(19) United States
(12) Patent Application Publication
(10) Pub. No.: US 2023/0038738 A1
(43) Pub. Date: Feb. 9, 2023

(54) METHOD FOR DETERMINING ANGLE INFORMATION

(71) Applicant: HELLA GmbH & Co. KGaA, Lippstadt (DE)

(72) Inventors: Tobias BREDDERMANN, Lippstadt (DE); Ernst WARSITZ, Paderborn (DE); Christian WESTHUES, Hamm (DE)

(73) Assignee: HELLA GmbH & Co. KGaA, Lippstadt (DE)

(21) Appl. No.: 17/960,548

(22) Filed: Oct. 5, 2022

Related U.S. Application Data
(63) Continuation of application No. PCT/EP2021/057462, filed on Mar. 23, 2021.

(30) Foreign Application Priority Data
Apr. 6, 2020 (DE) 10 2020 109 502.3

(51) Int. Cl. G01S 13/72; G01S 13/931

(52) U.S. Cl. CPC G01S 13/72; G01S 13/931; G01S 2013/93271

(57) ABSTRACT

A method for determining angle information about a direction of a target object in a radar system for a vehicle, wherein the following steps are performed: providing a first item of sensing information for a first modulation mode of the radar system, providing at least one second item of sensing information for at least a second modulation mode of the radar system, and combining the sensing information for the different modulation modes in order to perform the determination of the angle information on the basis of the combined sensing information.

This nonprovisional application is a continuation of International Application No. PCT/EP2021/057462, which was filed on Mar. 23, 2021, and which claims priority to German Patent Application No. 10 2020 109 502.3, which was filed in Germany on Apr. 6, 2020, and which are both herein incorporated by reference.

### BACKGROUND OF THE INVENTION

### Field of the Invention

The present invention relates to a method for determining angle information. In addition, the invention relates to a radar system for determining angle information.

### Description of the Background Art

It is known from the prior art that radar systems are used in vehicles in order to provide driver assistance systems such as an automatic distance control system or an automatic lane change assist system. In this connection, a radar signal emitted by the radar system can be reflected by target objects in the environment of the vehicle, received, and evaluated in order to perform object detection. The object detection includes, for example, the determination of the distance and relative speed of the target objects. Continuous wave radar devices in which the emitted radar signals are frequency-modulated, for example, can be used as a radar system for this purpose. Furthermore, in the case of a multi-mode radar, more than one modulation scheme can also be used, and hence different radar signals with different modulation modes can also be emitted. The measurement quality of the radar system can be improved by this means.

The document US 2018/0321368 A1 discloses a multi-mode radar in which radar signals with different modulation modes are emitted.

However, it is frequently a disadvantage that the object detection in certain situations can still be too unreliable or erroneous.

### SUMMARY OF THE INVENTION

It is therefore an object of the present invention to at least partially overcome the above-described disadvantages. In particular, it is an object of the present invention to provide an improved method and system for operating a multi-mode radar.

Features and details that are described in connection with the method according to the invention also apply in connection with the radar system according to the invention and vice versa, so mutual reference is or can always be made with regard to the disclosure of the individual aspects of the invention.

The object is attained, in an exemplary embodiment, by a method for determining angle information about a direction of a target object in a radar system, in particular for a vehicle. The vehicle is, for example, a passenger car or a truck that has at least one driver assistance system. In this case, the angle information can serve to provide at least one function for the driver assistance system. In other words, the radar system can be functionally integrated into the driver assistance system. The driver assistance system is implemented as an automatic lane departure warning system or a distance controller, for example.

In the method according to the invention, the following steps can be performed, preferably sequentially in the specified order or in any order, wherein individual steps and/or all steps can also be performed repeatedly: providing a first item of sensing information for a first modulation mode of the radar system, wherein the first sensing information results, in particular, from received radar signals that were modulated in accordance with the first modulation mode; providing at least one second item of sensing information (which is to say also a third and/or fourth item of sensing information, etc., if applicable) for at least a second modulation mode (which is to say also a third and/or fourth modulation mode, etc., if applicable) of the radar system, wherein the second sensing information results, in particular, from received radar signals that were modulated in accordance with the second modulation mode, and preferably the additional sensing information results, in particular, from received radar signals that were modulated in accordance with the additional modulation modes; and/or combining the sensing information for the different modulation modes in order to perform the determination of the angle information on the basis of the combined sensing information.

Conventional methods determine the angle information only on the basis of the sensing information for a single modulation mode. The invention therefore has the advantage as compared to conventional solutions that the measurements for different modulation modes can be summed. The combination of the sensing information, in particular in the form of an addition, results in an SNR improvement and thus in an improved angle estimation.

Depending on the number of different modulation modes, still more (third, fourth, etc.) sensing information items for corresponding (third, fourth, etc.) modulation modes can be provided with the method according to the invention in addition to the first and second sensing information. The determination of the angle information can then be performed especially reliably, e.g., through digital beamforming for angle estimation, on the basis of the combined sensing information.

The angle information is advantageously information about an angle, in particular an angle of emergence and/or incidence, of the radar signals at the antennas of the radar system. The direction of the target object relative to the radar system can accordingly be determined on the basis of this angle. Multiple antennas, i.e., transmitting and/or receiving antennas, of a radar sensor of the radar system can be used for this purpose. The use of 2 to 20, preferably 4 to 16, preferentially 8 to 12 different antennas is possible, for example. The spatial distance of the antennas from one another causes, as a function of the angle, a transit time difference in the radar signals that are emitted and received through the antennas. A separate component signal can be ascertained from the sensing information for each antenna and for each target object at which radar signals are reflected. For this purpose, the received radar signals are digitized, for example, and at least one Fourier transform is performed thereon in order to obtain the sensing information in the form of a spectrum and to perform a peak detection therein. This is described in detail below.

A radar sensor of the radar system can have multiple antennas, as described above. Through the use of multiple receiving and/or transmitting antennas, for example in accordance with a MIMO transmission scheme, the direction of the target object can be detected in this way. The angle of emergence and/or incidence of the transmitted or received radar signals can be evaluated to this end. Especially when current driver assistance systems are used, adequate angular measurement capability is a critical prerequisite. Angular measurement capability is substantially influenced by the parameters of antenna aperture and SNR (signal-to-noise ratio). Here, aperture designates the greatest distance between two antennas of the radar sensor, and varies in proportion to angular measurement capability. The same relationship applies to the SNR of the target object.

To obtain one of the sensing information items, a radar signal in accordance with one of the modulation modes can first be emitted by the radar system through at least one transmitting antenna. The radar signal includes, for example, multiple sequentially emitted frequency ramps (hereinafter also referred to as chirps). The chirps can be frequency modulated in each case, and thus have a varying frequency. Linear frequency modulation, in which the frequency changes linearly within a specified bandwidth in a given chirp, is used in this case, for example.

Furthermore, more than one radar signal can also be emitted through the at least one transmitting antenna in accordance with different modulation modes. For ease of understanding, only two modulation modes are assumed hereinbelow, wherein still more modulation modes can be provided if applicable. In multi-mode operation of this nature, different chirp signals are used. The radar signals for different modulation modes thus differ with regard to the modulation of the chirps. In concrete terms, a bandwidth and/or a duration T1 or T2 and/or a chirp spacing and/or a center frequency of the individual chirps of the radar signals can be different for different modulation modes. This influences the measurement quality of the radar system, for example for the measurement range and/or the resolution for the distance and/or the relative speed of the target object. For example, two to five different modulation modes can be used.

The radar signals that are reflected by at least one target object and delayed by a respective signal transit time can be sensed as received signals by at least one receiving antenna of the radar system. The baseband signal with frequency f_{b}=fₛ−fₑ can be ascertained from the particular received signal. Here, fₛ is the frequency of the emitted radar signal and fₑ is the frequency of the received signal. The frequency f_{b} is a function of the signal transit time τ and thus of the distance R of the target object. When multiple antennas (which is to say transmitting and/or receiving antennas) are used, multiple radar signals reflected at the same target object can be received simultaneously or sequentially as received signals. These signals also have slightly different signal transit times τ from one another. This difference can be evaluated on the basis of a phase relation of the received signals in order to determine the angle information.

In order to perform the detection of the at least one target object, the sensing information can be determined on the basis of the received signal, and in particular on the basis of the baseband signal. The sensing information results from the digitized baseband signal or from at least one frequency analysis of the baseband signal, for example. Accordingly, the sensing information can be digital information, which is to say data values. When N chirps are emitted for a radar signal, then the duration of a given chirp is T1/N. After the duration T1, the processing of the sensing information can take place within the duration T2-T1. The complete measurement cycle thus has a duration of T2.

During the duration T1, the individual values of a received signal can be sensed so that the sensing information can be created from the sensed values and, if applicable, a preprocessing (such as a down-conversion and/or an analog/digital conversion and/or at least one Fourier transformation). The sensed values can be summarized as a matrix, in which the values are stored in time sequence in a two-dimensional manner in an M×N matrix with M samples per chirp and N chirps by the end of the duration T1. A first of the dimensions can be specific to a distance to the target object, and the other (second) of the dimensions can be specific to the Doppler frequency and thus to the relative speed of the target object. On the basis of this matrix, at least one spectrum can subsequently be ascertained through at least one Fourier transformation of the matrix, from which spectrum the relative speed and/or the distance of the at least one target object in the environment of the vehicle can be determined. In concrete terms, a spectrum can be ascertained from a first Fourier transformation (e.g., by columns) of the matrix in the direction of the first dimension (by columns), which spectrum is assembled in turn as a two-dimensional matrix, and from which the distance can be ascertained. The relative speed can then also be ascertained from a second Fourier transformation (by rows) in the direction of the second dimension of the spectrum. If multiple transmitting and/or receiving antennas are used, a third dimension can also be used for the received signals of the different transmitting and/or receiving antennas. In this case, multiple spectra are present for the different antennas after the second Fourier transformation. The result of the second Fourier transformation can thus be a three-dimensional matrix which, moreover, can correspond to the sensing information. However, this involves only data resulting from the received signals for a single modulation mode. An additional Fourier transformation in the direction of this third dimension can serve to determine an angle, and thus the direction of the target object. Conventionally, this determination of the angle is performed only on the basis of the sensing information for a single modulation mode.

With the invention, however, a combination of additional sensing information from additional modulation modes can advantageously be performed here first. One option for determining the angle information from the combined sensing information is then to perform a third Fourier transformation in the direction of the third dimension. The result of this third Fourier transformation can correspond to the angle information in this case. The angle information is what is called a beamforming (BF) spectrum, for example. The third Fourier transformation is performed at a location, which is to say in a bin, in the combined sensing information at which the target object is detected, for example. To this end, a peak detection takes place in the combined sensing information, for example.

In advantageous manner, provision can be made within the scope of the invention that the first and the at least one second sensing information items (and in particular a third sensing information item, etc.) each have at least two component signals. Each one of the items of sensing information can thus have the at least two component signals in each case. These signals can be specific to at least two radar signals that are emitted in accordance with an identical modulation mode and are reflected at the same target object and whose signal transit times differ as a function of the direction of the target object. The component signals of a sensing information item are thus always specific to radar signals of an identical modulation mode, and component signals of different sensing information items are specific to radar signals with different modulation modes. The transit times of the component signals of a sensing information item can differ as a function of direction when different antennas are used. This makes it possible to calculate the angle information by comparing the component signals with one another.

Furthermore, it is possible that the at least two radar signals are emitted or received by different antennas of a radar sensor of the radar system so that the different transit times are a function of the direction of the target object, and so that a first component signal of the at least two component signals is specific to a first antenna of the different antennas and a second component signal of the at least two component signals is specific to a second antenna of the different antennas. The component signals for multiple antennas M=0, 1, 2 . . . can be described in the form sₘ=aₘ exp(−l·Δφ₀ₘ+φ₀), for example. Δφ₀ₘ, designates the phase difference of the component signal of the first antenna O and the additional antenna m, which is a function of the transit time of the associated received radar signal at this antenna m. Moreover, aₘ designates the amplitude of the component signal, which is a function of the strength of the associated received radar signal at the antenna m, in particular. φ₀ designates the initial phase. If multiple modulation modes are now also used in addition to the different antennas, l can designate the corresponding index for the modulation modes. Then the aforementioned component signals exist for the additional modulation modes as well, and can be represented accordingly in the form sₘ^{l}=aₘ^{l}·exp(−l·Δφ₀ₘ+φ₀).

Provision can advantageously be made in the invention that a radar sensor of the radar system has at least two transmitting antennas that are spaced apart from one another and at least one receiving antenna so that the radar signals for an identical modulation mode are emitted by the at least two transmitting antennas, and/or that the radar sensor has at least two receiving antennas that are spaced apart from one another and at least one transmitting antenna so that the radar signals for an identical modulation mode are received by the at least two receiving antennas. In this way, different transit times of the radar signals can be obtained to determine the angle information as a function of the direction of the target object. This procedure can be repeated for the additional modulation modes.

Furthermore, it is possible for the following steps to be performed by the radar sensor of the radar system: emission, by the at least one transmitting antenna of the radar sensor, of at least one first radar signal in accordance with the first modulation mode; emission, by the at least one transmitting antenna, of at least one second radar signal in accordance with the second modulation mode; receiving, by the at least one receiving antenna of the radar sensor, of the first radar signal for the first modulation mode reflected at the target object and delayed by the transit time; and/or receiving, by the at least one receiving antenna of the radar sensor, of the second radar signal for the second modulation mode reflected at the target object and delayed by the transit time.

In this case, at least two transmitting antennas and/or at least two receiving antennas can be provided in order to produce the direction-dependent transit time difference.

In another option, provision can be made that the first sensing information is specific to the at least one received first radar signal and the second sensing information is specific to the at least one received second radar signal. As a result, the component signals of the first sensing information can also be associated with the first radar signal, and thus the first modulation mode, and the component signals of the second sensing information can be associated with the second radar signal, and thus the second modulation mode.

It is advantageous, moreover, when the following step is performed within the scope of the invention before the combining: recognition of the target object in the items of sensing information in order to select, in particular from the sensing information items for the different modulation modes, those component signals in each case that have information about the same target object.

In this context it is also possible to speak of a matching of the different sensing information items. This can serve to make different modulation modes compatible with one another. The sensing information of the different modulation modes is based on measurements that are made sequentially in time, if applicable. Therefore, identical target objects can have different positions in the sensing information items. In other words, through recognition of the target object in the sensing information, reflectors can be found that are characteristic for a specific target object. This is possible through peak detection, for example. In this way, it is possible to ascertain the peaks in the frequency spectrum of the individual modulation modes that belong to the same reflection center. In addition, the same target objects can be identified in different sensing information items by the means that they have the same relative speed and/or the same distance and/or the same direction to the radar sensor. Accordingly, the angle information concerning the direction can also be determined provisionally in the conventional manner on the basis of the (not combined) sensing information for the purpose of recognizing the target object. This provisionally determined angle information is then used for recognition of the target object in the sensing information items. Furthermore, the assumption that the direction of the target object has not changed between the measurements of the sensing information can be used in this decision scheme.

Provision can likewise be made in the method according to the invention that the information about the same target object includes at least one of the following items of information, which are provided in particular by the sensing information through at least one frequency analysis: a speed of the target object; and/or a distance of the target object.

The sensing information corresponds in this case to, e.g., the spectrum, possibly multidimensional, resulting from the frequency analysis, in particular Fourier transformation.

Moreover, it is possible within the scope of the invention that the selected component signals have different phase information items (and in particular phase information items that are not directly comparable) about the transit times of the radar signals, and/or that the following step is performed before the combining: performing a normalization of the selected component signals, in particular of the phase information items of these component signals, preferably in order to make component signals (and preferably their phase information items) for different modulation modes comparable.

Because of the different modulation modes, the radar signals for different modulation modes can be decoupled in time so that even the initial chirps of the radar signals are not synchronized. Consequently, a different phase relation of the radar signals can occur (even when the direction of the target object does not change), so that the phase information items of the different sensing information items are no longer comparable. The normalization can be performed for each of the sensing information items in order to nevertheless make the combination possible. In this process, only the component signals of a single sensing information item are ever taken into account in the normalization if applicable, and hence the component signals of different sensing information items (and thus different modulation modes) are not compared with one another.

It can further be possible that the following steps are performed for each item of sensing information in order to perform the normalization: providing a first component signal for a first antenna of the radar sensor; providing at least one second component signal for at least one second antenna of the radar sensor; and/or processing, in particular dividing, the at least one second component signal by the first component signal.

Each sensing information item can thus have multiple component signals that can be associated with different antennas (receiving and/or transmitting antennas) of the radar sensor, which is to say can result from the radar signals received or emitted there. The items of phase information of these (selected) component signals of a sensing information item thus differ as a function of the direction of the target object.

For the normalization, the component signals for the individual sensing information items can be divided as complex signals, always by the complex signal of the first antenna if applicable. For example, for each modulation mode (e.g., l=0, 1, 2 . . . the normalized component signals s̅ are obtained from:

$${\overline{s}}_{m}^{l} = \frac{{s}_{m}^{l}}{{s}_{0}^{l}}$$

Thus, for example, for l=0 the first component signal s⁰₀ of the first antenna is first divided by the (same) first component signal s⁰₀ of the first antenna in order to obtain the normalized first component signal s⁰₀ of the first antenna, then the second component signal s⁰₁ of the second antenna is divided by the first component signal s⁰₀ of the first antenna to obtain the normalized second component signal s⁰₁ of the second antenna, and so on. This can initially be repeated for an individual sensing information item of one modulation mode and then be repeated for the individual sensing information items of the other modulation modes. In other words, the antenna phases φₘ^{l}, are normalized to the antenna phase φ8. The resultant normalized component signals are then present in the form sₘ^{l}=aₘ^{l}·exp(−l·Δφₗₘ). Ideally, the phase differences Δφₗₘ are equal and thus comparable as a result of the normalization for the different modulation modes l. Consequently, when the phase differences Δφₗₘ differ owing to interference, a summing of the component signals can thus result in an improved signal-to-noise ratio.

Provision can therefore be made that the combining is performed by the means that the selected, and in particular normalized, component signals of the same antennas and different sensing information items, and thus for different modulation modes, are summed, in particular added. In other words, for each antenna m, all signals s^{l}ₘ can be summed according to

$${s}_{m} = {\sum }_{l = 0}^{L - 1} {\overline{s}}_{m}^{l} .$$

After that, the determination of the angle information can be performed in the manner of an angle estimation (e.g., by means of digital beamforming) on the basis of the signals thus obtained (which is to say the combined component signals sₘ).

Provision can furthermore be made within the scope of the invention that the determination of the angle information on the basis of the combined sensing information is performed by the means that, after the combining, the direction of the target object is determined as additional information by a processing of the summed component signals of different antennas with one another, in particular by an additional frequency analysis. The addition of the signals in this process results in an SNR improvement, and thus in an improved angle estimation, as compared to the angle estimation on the basis of only one sensing information item for an individual modulation mode.

Moreover, it is possible within the scope of the invention that the radar system emits at least three different radar signals in accordance with a multi-mode operation in order to ascertain the first and second and a third sensing information item on the basis of the received radar signals for three different modulation modes, wherein the radar signals of the radar system are modulated differently in the different modulation modes.

The subject of the invention is likewise a radar system for a vehicle. In addition to the detection of target objects, the radar system can also serve to determine angle information about a direction of the target object in question. To this end, the radar system can have an (electronic) processing device for carrying out a method according to the invention. As a result, the radar system according to the invention provides the same advantages as have been described in detail with respect to a method according to the invention. The processing device is implemented as, for example, a microcontroller or digital signal processor or the like.

In an additional option, provision can be made that the radar system is implemented as a continuous wave radar. In concrete terms, the radar system can be implemented as a frequency modulated continuous wave radar (FMCW radar).

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic representation of a vehicle with a radar system according to the invention in a side view;

FIG. 2 is a schematic top view of a vehicle with a radar system according to the invention;

FIGS. 3-6 are additional schematic representations of parts of a radar system according to the invention;

FIG. 7 is a schematic representation of steps of a method according to the invention; and

FIG. 8 is a schematic representation of radar signals with different modulation modes.

### DETAILED DESCRIPTION

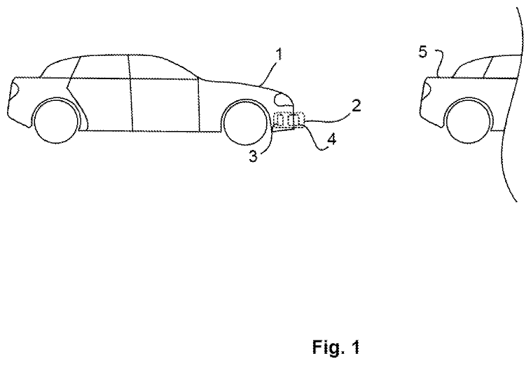

In FIG. 1, a vehicle 1 with a radar system 2 according to the invention is shown schematically in a side view. The vehicle 1 can employ the radar system 2 according to the invention for use with a driver assistance system, for example. In this case, the radar system 2 can also serve to determine angle information 200 about a direction of a target object 5 in addition to determining a distance and a speed. In order to perform the requisite signal processing, the radar system 2 can have an electronic processing device 3 for carrying out a method according to the invention. The processing device 3 is electrically connected to a radar sensor 4, which has multiple antennas 20, 21.

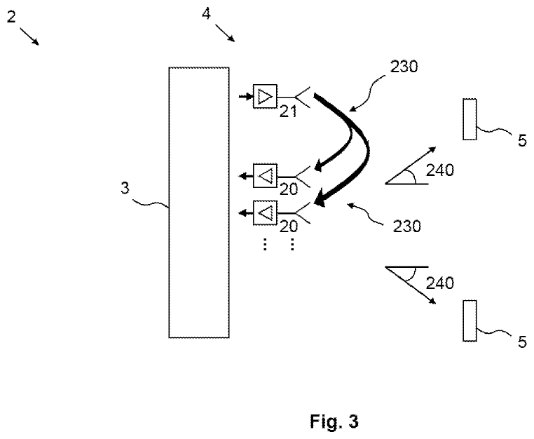

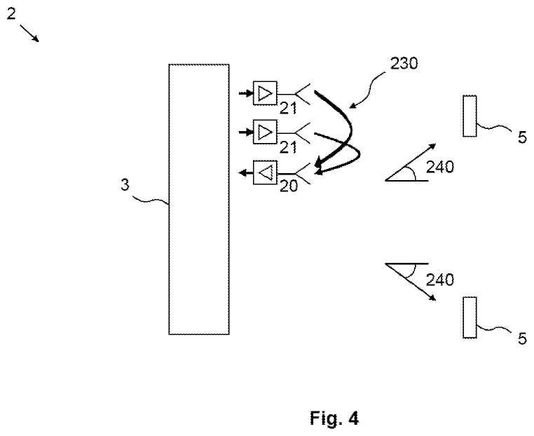

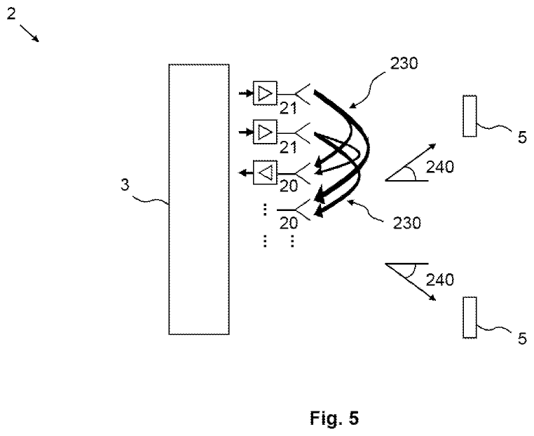

In FIGS. 3 to 6, the arrangement of the antennas 20, 21 is shown with additional details. According to FIG. 3, the radar sensor 4 of the radar system 2 has, for example, at least two receiving antennas 20 that are spaced apart from one another and only one transmitting antenna 21. In FIG. 4, in contrast, at least two transmitting antennas 21 that are spaced apart from one another and only one receiving antenna 20 are provided for the radar sensor 4. In FIG. 5, an MIMO (multiple-input multiple-output) transmitting and receiving scheme is used for the radar system 2. The use of more than two antennas 20, 21 can make it possible to ascertain the angle 240 (angle of emergence and/or incidence) of the radar signals through a comparison of the different transit times on the basis of the phases of the radar signals 230. This consequently permits the determination of the angle information 200 as information about this angle 240 and thus about the direction of the target object 5.

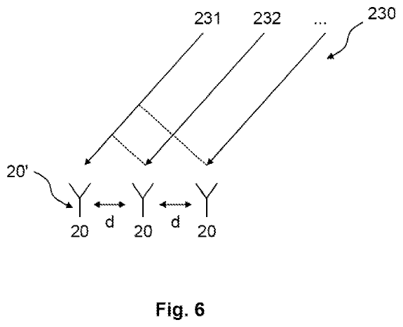

The option for determining the angle information 200 is illustrated in FIG. 6 with additional details. It can be seen there that the transit times, and thus phases, of the radar signals 230 vary with respect to the first receiving antenna 20′ on account of the distances d of the receiving antennas 20 from one another and on account of the angle of incidence of the radar signals 230 and thus the direction of the target object 5. A first radar signal 231 and a second radar signal 232 are shown by way of example for purposes of illustration.

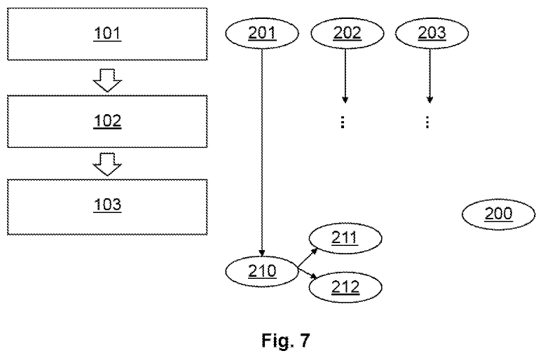

In FIG. 7, a method according to the invention for determining the angle information 200 about the direction of the target object 5 in the radar system 2 for the vehicle 1 is visualized schematically. According to a first method step 101, provision of a first item of sensing information 201 for a first modulation mode 251 of the radar system 2 can be accomplished here. According to a second method step 102, furthermore, provision of at least one second item of sensing information 202 for at least a second modulation mode 252 of the radar system 2 is performed. The sensing information items here represent the “measured values” of the radar system 2, which can be ascertained by the emitting and receiving of the radar signals and, if applicable, a subsequent signal processing. The first sensing information 201 here results from an emitting and receiving of such radar signals, which were modulated in accordance with a first modulation mode 251. The second sensing information 202 results from an emitting and receiving of such radar signals 230, which were modulated in accordance with a second modulation mode 252. A third item of sensing information 203 of a third modulation mode 253 can also be provided, if applicable. According to a third method step 103, a combining of the sensing information items 201, 202, 203 for the different modulation modes 251, 252, 253 takes place. In this way, the determination of the angle information 200 can be performed on the basis of the combined sensing information 201, 202, 203.

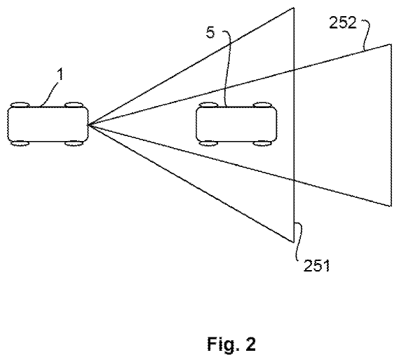

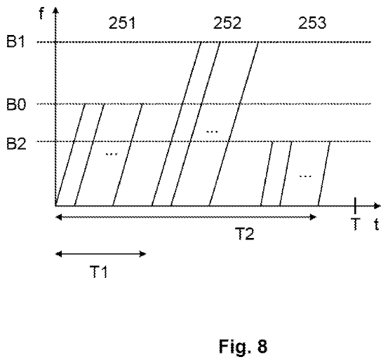

The radar signals 230 with different modulation modes differ by the manner in which the radar signals 230 are modulated, in particular. It is shown in FIG. 8 that the bandwidths B0, B1, B2 can differ, for example. The radar signals 230 can also be modulated differently with regard to the frequency f. The different radar signals 251, 252, 253 can be output in chronological succession here, and can also have a different duration with regard to the time t. It is shown in FIG. 2 that different sensing regions can be covered by the different modulation modes 251, 252 in this way.

Furthermore, the first and the at least one second sensing information items 201, 202 can each have at least two component signals 210, wherein the at least two component signals 210 in each case are specific to at least two radar signals 230 that are emitted in accordance with an identical modulation mode 251, 252 and are reflected at the same target object 5 and whose signal transit times differ as a function of the direction of the target object 5. In other words, a first component signal 211 and at least one second component signal 212 can be provided for each sensing information item 201, 202. Because these signals result from the same sensing information items 201, 202, they are also specific to an identical (single) modulation mode 251, 252. Nevertheless, the component signals 251, 252 can be specific to different antennas 20, 21 of the radar system 2.

In FIG. 6 the radar sensor is shown with three receiving antennas 20 by way of example. It can be seen that a distance d, which influences the angle of incidence of the radar signals 230, is provided between the receiving antennas 20. A received signal can be electrically evaluated at each of the receiving antennas 20 as a function of the received radar signal 230. For the received signal sₘ at the m-th receiving antenna the following applies:

sₘ=aₘ exp(−l·Δφ₀ₘ+φ₀)

where designates the received amplitude, Δφ₀ₘ designates the phase difference between a first receiving antenna 20′ and an m-th receiving antenna 20, and φ₀ designates the initial phase.

Thus, the following applies for the angle α:

$$α = a sin ( \frac{{Δφ}_{0 m}}{k \cdot {d}_{0 m}} ) .$$

Now, if the received signal is distorted, the following relationship results for the estimated angle α̅:

$$α = a sin ( \frac{k \cdot {d}_{0 m}}{} ) with = {Δφ}_{0 m} + {n}_{0 m} ,$$

where [symbol] designates the measured phase difference and n₀ₘ designates the associated noise term.

It is immediately evident from these equations that an increase in the SNR (smaller n₀ₘ) and an increase in the aperture (larger d₀ₘ) result in a better angle estimate (smaller n at the output of the estimator).

As is shown in FIG. 8, the radar system 2 in multi-mode operation can emit different modulation schemes for each cycle in order to take into account the different requirements on measurement capability at close and long ranges. Emission can take place through the same or different transmitting antennas 21. For close range applications, nonfocused, omnidirectional antennas can be used, for example, and for long range applications sharply focusing antennas can be employed, for example. In this context, the different combinations of modulation mode 251, 252 & transmitting antenna 21 can have regions of overlap in which redundant information about a target object 5 is present (see FIG. 2).

The basic signal processing (which is to say data acquisition and frequency analysis and raw target determination) can take place separately for each modulation mode. Conventionally, a merging of the information can only take place at higher levels of abstraction (e.g., raw target level or object level). In this context, a raw target designates a reflection (local peak in the frequency range) with the associated attributes of distance, speed, angle, SNR, various qualities, etc.). According to the invention, multi-mode operation can be used to improve angle calculation. In general, L modulation modes can be merged at the raw signal level under the condition that the target object 5 is located within the FOV (Field Of View) of all modulation modes (see FIG. 2). Furthermore, all modulation modes can be transmitted within a measurement cycle of duration T using time-division multiplexing in accordance with FIG. 8.

The above explanation of the embodiments describes the present invention solely within the framework of examples. Individual features of the embodiments can of course be combined freely with one another, insofar as is technically appropriate, without departing from the scope of the present invention.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for determining angle information about a direction of a target object in a radar system for a vehicle, the method comprising:
providing a first item of sensing information for a first modulation mode of the radar system;
providing at least one second item of sensing information for at least a second modulation mode of the radar system; and
combining the first item and second item sensing information for the different modulation modes to perform a determination of the angle information on the basis of the combined sensing information.

2. The method according to claim 1, wherein the first and the at least one second sensing information items each have at least two component signals, wherein the at least two component signals are specific to at least two radar signals that are emitted in accordance with an identical modulation mode and are reflected at the same target object and whose signal transit times differ as a function of the direction of the target object.

3. The method according to claim 2, wherein the at least two radar signals are emitted or received by different antennas of a radar sensor of the radar system so that the different transit times are a function of the direction of the target object and so that a first component signal of the at least two component signals is specific to a first antenna of the different antennas and a second component signal of the at least two component signals is specific to a second antenna of the different antennas.

4. The method according to claim 2, wherein a radar sensor of the radar system has at least two transmitting antennas that are spaced apart from one another and at least one receiving antenna so that the radar signals for an identical modulation mode are emitted through the at least two transmitting antennas and/or wherein the radar sensor has at least two receiving antennas that are spaced apart from one another and at least one transmitting antenna so that the radar signals for an identical modulation mode are received by the at least two receiving antennas in order to obtain different transit times of the radar signals to determine the angle information as a function of the direction of the target object.

5. The method according to claim 4, wherein the following steps are performed by the radar sensor of the radar system:
emitting, by the at least one transmitting antenna of the radar sensor, at least one first radar signal in accordance with the first modulation mode;
emitting, by the at least one transmitting antenna, at least one second radar signal in accordance with the second modulation mode;
receiving, by the at least one receiving antenna of the radar sensor, the first radar signal for the first modulation mode reflected at the target object and delayed by the transit time; and
receiving, by the at least one receiving antenna of the radar sensor, the second radar signal for the second modulation mode reflected at the target object and delayed by the transit time.

6. The method according to claim 5, wherein the first sensing information is specific to the at least one received first radar signal and the second sensing information is specific to the at least one received second radar signal.

7. The method according to claim 2, wherein the following step is performed before the combining:
recognizing the target object in the items of sensing information in order to select, from the sensing information items for the different modulation modes, those component signals in each case that have information about the same target object.

8. The method according to claim 7, wherein the information about the same target object includes at least one of the following items of information, which are provided by the sensing information through at least one frequency analysis:
a speed of the target object; or
a distance of the target object.

9. The method according to claim 7, wherein the selected component signals have different phase information items about the transit times of the radar signals, wherein the following step is performed before the combining:
performing a normalization of the selected component signals, in particular of the phase information items, in order to make component signals for different modulation modes comparable.

10. The method according to claim 9, wherein the following steps are performed for each item of sensing information in order to perform the normalization:
providing a first component signal for a first antenna of the radar sensor;
providing at least one second component signal for at least one second antenna of the radar sensor; and
processing or dividing the at least one second component signal by the first component signal.

11. The method according to claim 7, wherein the combining is performed in that the selected, and in particular normalized, component signals of the same antennas and different sensing information items, and thus for different modulation modes, are summed, in particular added.

12. The method according to claim 7, wherein the determination of the angle information on the basis of the combined sensing information is performed in that, after the combining, the direction of the target object is determined as additional information by a processing of the summed component signals of different antennas with one another, in particular by an additional frequency analysis.

13. The method according to claim 1, wherein the radar system emits at least three different radar signals in accordance with a multi-mode operation in order to ascertain the first and the second and a third sensing information item on the basis of the received radar signals for three different modulation modes, wherein the radar signals of the radar system are modulated differently in the different modulation modes.

14. A radar system for a vehicle for determining angle information about a direction of a target object, the system comprising a processing device to perform the method according to claim 1.

15. The radar system according to claim 14, wherein the radar system is a continuous wave radar.
